(19) United States
(12) Patent Application Publication
(10) Pub. No.: US 2014/0137883 A1
(43) Pub. Date: May 22, 2014

(54) RAZOR INCLUDING AN IMAGING DEVICE

(71) Applicant: REAGAN INVENTIONS, LLC, Sunny Isles Beach, FL (US)

(72) Inventor: LEIGH M. ROTHSCHILD, SUNNY ISLES BEACH, FL (US)

(73) Assignee: REAGAN INVENTIONS, LLC, SUNNY ISLES BEACH, FL (US)

(21) Appl. No.: 13/683,788

(22) Filed: Nov. 21, 2012

(51) Int. Cl. B26B 21/40; B26B 21/42

(52) U.S. Cl. CPC B26B 21/40; B26B 21/42; B26B 21/4081; B26B 21/4056
USPC 132/200; 30/34.05

(57) ABSTRACT

A razor, which includes at least one blade, that detects when it is adjacent to skin. Via an imaging device coupled to the razor, whether an area of the skin is sensitive to shaving is determined. Responsive to determining that the area of the skin is sensitive to shaving, the razor automatically adjusts a position of the blade with respect to a hair cutting plane defined by a protective device coupled to the razor that limits proximity of the blade to the skin.

### BACKGROUND

Razors commonly are used for shaving. Razors are available in a variety of configurations. The simplest razor, and perhaps the oldest, is a straight razor. A straight razor includes a single blade, which oftentimes is configured to be folded into a handle when the straight razor is not in use. During use, a user moves the edge of the blade across the skin to effectuate the cutting of hair/whiskers protruding from the skin.

Since the advent of the straight razor, other types of razors have been developed. For example, many manufacturers produce safety razors. A safety razor includes one or more blades positioned at a right angle to the razor's handle, and a protective device positioned between the edge of the blade(s) and the skin to mitigate the risk of the blade(s) cutting through the skin.

Electric razors also are common. An electric razor includes one or more rotating or oscillating blades, and a protective device positioned between the blade(s) and the skin. The rotation/oscillation is powered by an electric motor. Electric razors typically do not require the use of shaving cream.

### SUMMARY

The present description relates to a razor including an imaging device. An embodiment of the present arrangements can include a method of controlling a razor. The method can include detecting the razor being adjacent to skin, the razor comprising at least one blade. Via an imaging device coupled to the razor, a determination can be made as to whether an area of the skin is sensitive to shaving. The method also can include, responsive to determining that the area of the skin is sensitive to shaving, automatically adjusting a position of the blade with respect to a hair cutting plane defined by a protective device coupled to the razor that limits proximity of the blade to the skin.

Another embodiment can include a razor including at least one blade and a processor configured to initiate executable operations. The executable operations can include detecting that the razor is adjacent to skin, via an imaging device coupled to the razor, determining whether an area of the skin is sensitive to shaving and, responsive to determining that the area of the skin is sensitive to shaving, automatically adjusting a position of the blade with respect to a hair cutting plane defined by a protective device coupled to the razor that limits proximity of the blade to the skin.

Another embodiment can include a computer program product for controlling a razor. The computer program product can include a computer-readable storage device having stored thereon program code that, when executed, configures a processor to perform executable operations. The executable operations can include detecting that the razor is adjacent to skin, via an imaging device coupled to the razor, determining whether an area of the skin is sensitive to shaving and, responsive to determining that the area of the skin is sensitive to shaving, automatically adjusting a position of the blade with respect to a hair cutting plane defined by a protective device coupled to the razor that limits proximity of the blade to the skin.

### BRIEF DESCRIPTION OF THE DRAWINGS

FIG. 1 depicts a shaving system, which is useful for understanding various arrangements described herein.

FIG. 2 depicts a block diagram of a system of a razor, which is useful for understanding various arrangements described herein.

FIG. 3 depicts a block diagram a processing system, which is useful for understanding various arrangements described herein.

FIG. 4 is a flowchart presenting a method of controlling a razor, which is useful for understanding various arrangements described herein.

### DETAILED DESCRIPTION

While the specification concludes with claims defining features of the embodiments described herein that are regarded as novel, it is believed that these embodiments will be better understood from a consideration of the description in conjunction with the drawings. As required, detailed arrangements of the present embodiments are disclosed herein; however, it is to be understood that the disclosed arrangements are merely exemplary of the embodiments, which can be embodied in various forms. Therefore, specific structural and functional details disclosed herein are not to be interpreted as limiting, but merely as a basis for the claims and as a representative basis for teaching one skilled in the art to variously employ the present embodiments in virtually any appropriately detailed structure. Further, the terms and phrases used herein are not intended to be limiting but rather to provide an understandable description of the present arrangements.

Arrangements described herein relate to a razor having an imaging device coupled thereto. The razor includes at least one blade for cutting hair, such as whiskers or other hair that grows on a living being. The razor also includes an imaging device that captures images of an area of skin being shaved. The images/video can be communicated to a display, for example for a user to view while shaving. Further, the images/video can be analyzed to identify areas of the skin that are sensitive to shaving, such as areas that show signs of skin disease or other skin condition. When one or more of such areas are identified, the razor can automatically generate an alert indicating that the area of the skin is sensitive to shaving. Further, the position (e.g., height) of the razor's blade(s), respective to the skin, can be automatically adjusted when the razor is shaving hair growing in the sensitive area to minimize skin irritation in the sensitive area. Also, in one arrangement, via the imaging device, the razor can capture one or more images of the sensitive area and communicate the image(s)/video to a medical practitioner (e.g., a physician, such as a dermatologist) to facilitate diagnosis of a condition to which the sensitive area may be attributed.

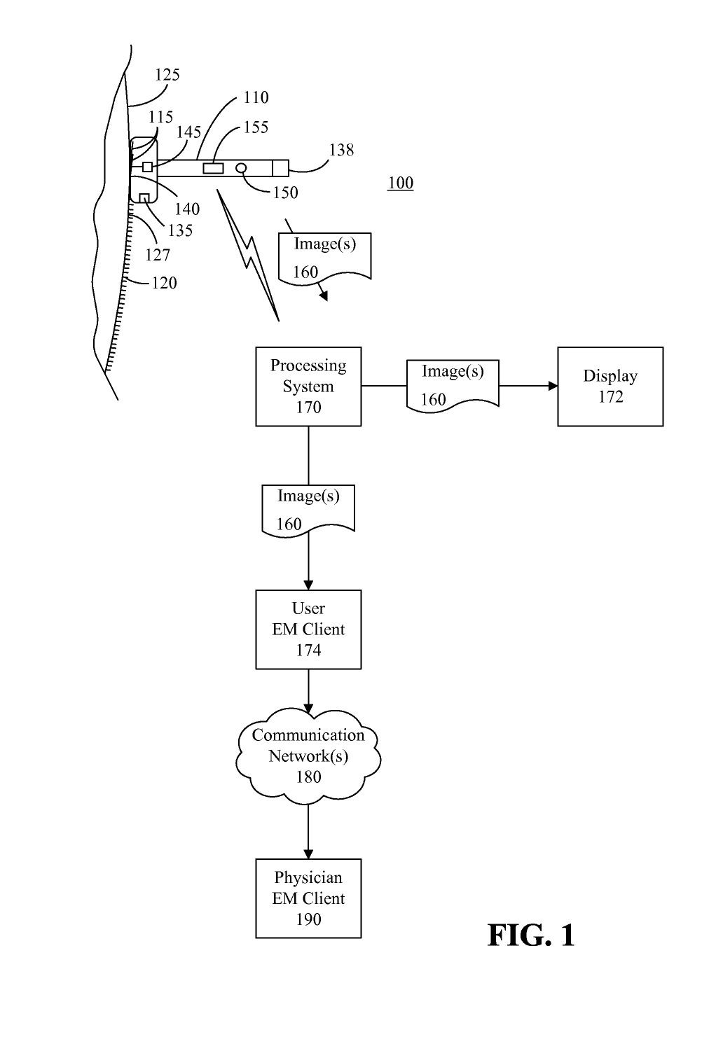

FIG. 1 depicts a shaving system (hereinafter “system”) 100, which is useful for understanding various arrangements described herein. The system 100 includes a razor 110 comprising one or more blades 115 disposed within the razor 110 adjacent to skin 125 of a user and configured to cut hair (e.g., whiskers) 120 protruding from skin 125. One or more imaging devices 135 are coupled to the razor 110. As used herein, the term “coupled” means attached to or integrated with. Specifically, the imaging device 135 can be an external device attached to the razor 110, or integrated as a component of the razor 110. The imaging device(s) 135 is/are configured to capture one or more images 160 (e.g., as still images or video) of the skin 125 being shaved by the razor 110. Hereinafter, reference to capturing an image, capturing at least one image or capturing images means capturing one or more still images or video.

For example, an imaging device 135 can capture one or more images 160 of an area of the skin 125 proximate to the razor 110, and located in front of the razor 110, based on the direction the razor is intended to be moved across the skin 125 while a user is shaving. In an arrangement in which the razor 110 is configured to be moved across the skin in more than one direction while shaving (e.g., as an electric razor may be configured to operate), the razor 110 can include a plurality of imaging devices 135 to capture images 160 of multiple regions of the skin 125 proximate to various sides of the razor 110.

An imaging device 135 can be a charged coupled device (CCD), a complementary metal-oxide-semiconductor (CMOS) sensor, or any other sensor suitable for capturing one or more images 160 of the skin 125. Further, a light source (not shown), such as a light emitting diode, a liquid crystal display (LCD), a lamp, or other suitable source of light can be coupled to the razor 110 to illuminate areas of the skin 125 for which one or more images 160 is captured.

Further, the razor 110 can include a processor (not shown in FIG. 1) configured to process images 160 captured by the imaging device 135 to perform the functions described herein. The razor 110 also can include one or more machine-readable (or computer-readable) data storage devices (hereinafter “storage devices”) having stored thereon machine-readable (or computer-readable) program code configured to, when executed by the processor, configures the processor to perform the functions and operations described herein as being performed by the razor 110. In illustration, a shaving application (not shown in FIG. 1) can be stored on a storage device in the form of executable program. One or more of the storage device(s) also can be configured to store one or more images 160 (e.g., still images and/or video) of the skin 125 captured by the imaging device 135.

In one arrangement, one or more of the storage device(s) can be removable. By way of example, one or more applications can be stored on a first storage device (not shown in FIG. 1) that is fixed within the razor 110, and the images 160 of the skin 125 can be stored on a second storage device 138 that is removably attached to the razor 110. Accordingly, after the razor 110 has been used to capture the images of the skin 125, a user can remove the second storage device 138 and access the images 160 from another suitable device to which the second storage device 138 later is connected. In illustration, the second storage device 138 can be a memory card comprising flash memory, a flash drive, or the like. In another arrangement, the images 160 can be stored to the first storage device (not shown) or the second storage device 138 at least until the images 160 are communicated to another device or system (e.g., via wired or wireless communications), as will be described herein. Such communication, for example, can take place when the images 160 are captured, or at some later time, for instance when such communication is initiated by the user.

The razor 110 can be configured to detect when the razor 110 is adjacent to the skin 125. For example, the razor 110 can process images detected by the imaging device 135 to detect when the razor 110 is adjacent to the skin 125, or receive an input from a proximity sensor (not shown) that indicates whether the razor 110 is adjacent to the skin 125. The image analysis or proximity sensor also may precisely identify the distance between at least one portion of the razor 110, such as a protective device 140, and the skin 125.

The razor 110 further can be configured to selectively adjust the position of the blades 115 with respect to the skin 125. In illustration, the razor 110 can include the protective device 140, which is configured to be disposed against the skin 125 and that limits proximity of the blade(s) 115 to the skin 125. For instance, the protective device 140 can include a planar or curved surface having an opening through which the blades 115 can engage and cut the hair 120. In this regard, the protective device 140 can define a hair cutting plane.

A blade adjuster 145 can adjust the position of the blade(s) 115 with respect to the hair cutting plane, for example to move the blade(s) 115 away from the skin 125 when an area of the skin 125 that is sensitive to shaving is identified by the processor when processing of one or more images captured by the imaging device(s) 135. The blade adjuster 145 can be implemented using an electrical motor, piezoelectric device, a nanotube motor, or any other blade positioning device communicatively linked to the processor. In this regard, the blade adjuster 145 can adjust the height of the blade(s) 115 in response to one or more signals generated by the processor.

The distance that the blade(s) 115 is moved away from the skin can be determined based on an analysis of the captured image(s) performed by the razor 110. In illustration, if such analysis identifies a skin disease or skin conduction, such as erythema (e.g., redness of the skin) or dryness of the skin, the blade(s) 115 can be moved a small distance away from the skin 125, for example 0.2 mm, 0.4 mm, 0.6 mm, 0.8 mm, etc. from the plane defined by the protective device 140. If the analysis identifies skin neoplasms (also known as “skin cancer”) and/or one or more lacerations of the skin 125, the blade(s) 115 can be moved an intermediate distance away from the skin, for example 1.0 mm, 1.5 mm, 2.0 mm, or the like. If the analysis identifies one or more areas of the skin 125 where the skin is protruded, for example due to acne, inflammation, scabbing or scaring, the blade(s) 115 can be moved an appropriate distance that mitigates a risk of the blade(s) 115 cutting into the skin, scab and/or scar tissue.

Further, the razor 110 can include an output audio transducer 150 configured to output an alert when the razor 110 is proximate to an area of the skin 125 that is sensitive to shaving. In this regard, the razor 110 can include at least audio processor (not shown in FIG. 1) communicatively linked, or incorporated into, the processor previously described. In illustration, when a sensitive area is identified based on processing, by the previously described processor, of one or more images captured by the imaging device 135, the processor can generate a signal to the audio processor which, in response, can output an audio signal to the output audio transducer 150 to generate an audible alert indicating that the razor 110 is proximate to the sensitive area. Further, responsive to the processor determining whether an area of the skin is sensitive to shaving, or exhibits symptoms of a skin disease or other undesirable skin condition, an audio signal can be generated to indicate such condition. The alert also can indicate a type of blade that should be used for shaving. For instance, the type of blade can be a type of blade configured for sensitive skin, for rough beards, or the like. The alert can be communicated to the output audio transducer 150 via the audio processor.

The razor 110 also can detect when a charge level of a battery of the razor 110 that is low, and/or when the razor blade(s) 115 need to be replaced or sharpened, and the processor can generate corresponding signals to the output audio transducer 150 to generate corresponding audible alerts. To determine when the razor blade(s) 115 need to be replaced or sharpened, the razor 110 can track the cumulative amount of time spent shaving since the razor blade(s) 115 were last replaced or sharpened (or since the razor 110 was first operated).

The aforementioned alerts also may be output to a display, or to one or more indicator lamps (e.g., LEDs), integrated into the razor 110 for presentation to the user. Such alerts also may be communicated to an external display 172, as will be described herein.

The razor 110 further can be configured to capture at least one image of the skin via the imaging device(s) 135 and wirelessly communicate image(s) 160 captured by the imaging device 135 to a processing system 170 for presentation on a display 172. The display 172 can be activated when the razor 110 is turned on, can be activated by the user, or can be activated in any other suitable manner. In illustration, when the razor 110 is turned on, the razor's processor can activate the display 172.

The razor 110 can include a communication adapter 155 that communicates the image(s) 160 to a communication adapter of the processing system 170. In one arrangement, the communication adapters 155, 170 can be wireless communication adapters. In another arrangement, the communication adapters can be wired communication adapters.

In an arrangement in which the communication adapters 155, 170 are wireless communication adapters, the razor 110 can communicate the image(s) 160 to the processing system 170 in accordance with a suitable personal area network (PAN) protocol, such as Bluetooth® or Zigbee®, or in accordance with a digital living network alliance (DLNA) protocol. In further arrangements, the razor 110 can communicate the image(s) 160 to the processing system 170 in accordance with IEEE 802 wireless communications, for example, 802.11(e.g., WiFi™) and 802.16 (WiMax), mobile WiMax, WPA, or WPA2. Still, any other type of wired or wireless communications suitable for communicating the image(s) 160 from the razor 110 to the processing system 170 can be used and the present arrangements are not limited in this regard.

The processing system 170 can process the image(s) 160 into a format suitable for presentation on the display 172, and output the image(s) 160 to the display 172 for presentation to the user while the user is shaving. Accordingly, the user can view the area of the skin 125 on the display 172. Moreover, the view of the area can be enlarged to provide greater detail than the user otherwise may perceive simply using a mirror.

The aforementioned alerts generated by the razor 110 can be presented on the display 172. For example, the alerts previously described can be communicated to the processing system 170, and the processing system 170 can present the alerts on the display 172, for example as messages, pop-up windows, or the like. Further, the razor 110 can communicate to the processing system 170 the current charge level of the razor's batter, and the processing system 170 can provide a corresponding battery charge level indicator on the display 172. The razor 110 also can communicate to the processing system 170 an indicator that indicates a type of blade that should be used based on the condition of the user's skin 125 and/or hair (or whiskers) 120. The processing system 170 can present a corresponding message on the display 172.

In one arrangement, the display 172 can be integrated into a mirror, for example in a bathroom mirror. The display 172 can be continuously visible in the mirror, or visible only visible when the display 172 is active. For example, the display can be placed in a two-way mirror, which is known in the art. When the display 172 is not active, the region of the mirror in which the display 172 is integrated can reflect light in a manner typical for a mirror. When the display 172 is active, however, that region of the mirror can present the image(s) 160. The processing system 170 can automatically activate (e.g., turn on) the display 172 when the razor 110 is turned on.

In another system, the display 172 can be integrated into the processing system 170. For example, the processing system 170 can be a laptop computer, a notebook computer, a tablet computer, a smart phone, a personal digital assistant, or the like, having an integrated display. In illustration, the user can hold the processing system 170, or set the processing system 170 on a counter or shelf, while shaving. Further, the image(s) captured by the imaging device 135 can be presented on the display 172 as a reverse image (i.e., mirror image), though the present arrangements are not limited in this regard.

Further, via the razor 110 and/or the processing system 170, the user can adjust the size of the image presented on the display 172, for example by zooming in or zooming out. The user can zoom in and/or zoom out using one or more buttons or other controls provided on the razor 110, using a mouse, touchpad or keyboard of the processing system 170, by touching the display 172 (e.g., when the display 172 is a touchscreen), or by providing one or more gestures recognized by the processing system 170 and/or the display 172. Touchscreens and gesture recognition are known to those of ordinary skill in the art.

The processing system 170 also can be configured to communicate the image(s) 160 to a desired entity, for example to a medical practitioner (e.g., a physician or medical office). As noted, via the imaging device(s) 135, the razor 110 can capture one or more images of the skin 125 and the razor's processor can analyze such images to determine whether the skin 125 is afflicted by skin disease or other undesirable skin condition. For example, the razor 110 can be configured to identify erythema, skin neoplasms (e.g., basal cell carcinoma, squamous cell carcinoma, malignant melanoma, etc.), dry skin, and so on.

Responsive to the processor determining that the areas of the skin 125 are sensitive to shaving, or otherwise exhibit symptoms of a skin disease or undesirable skin condition, the processor can communicate one or more images of such areas of the skin 125 to a medical practitioner, for example via a suitable communications adapter (wired or wireless) coupled to one or more suitable communication networks 180. Accordingly, when an area of the skin should be looked at by a medical practitioner (or other person), one or more corresponding image(s) 160 can be communicated to that person.

For example, the user can configure the processing system 170 with the medical practitioner's EM identifier. In one arrangement, the user can select a button (not shown) on the razor 110, or select a button or icon presented by a user interface of the processing system 170, to initiate communication of the image(s) 160 to the medical practitioner. In another arrangement, communication of the image(s) 160 to the medical practitioner can be implemented automatically upon the sensitive areas of the skin 125 being identified.

In illustration, the processing system can include, or otherwise communicatively linked, to an electronic messaging (EM) client, such as a user EM client 174. The processing system 170 can cause the user EM client 174 to communicate the image(s) 160 to a medical practitioner by attaching the image(s) 160 to an electronic message communicated to the medical practitioner via one or more suitable communication networks 180. The communication networks 180 can include the Internet, a wide area network (WAN), a local area network (LAN), one or more wireless networks (e.g., cellular communication networks, WiFi™ networks, PANs, etc.) and/or any other communication networks suitably configured to support communication of images. The medical practitioner can receive and view the image(s) 160 on a suitable processing system executing a medical practitioner EM client 190. The user EM client 174 and medical practitioner EM client 190 can be email clients, text message clients, instant messaging clients, or any other type of electronic messaging clients suitable for communicating images.

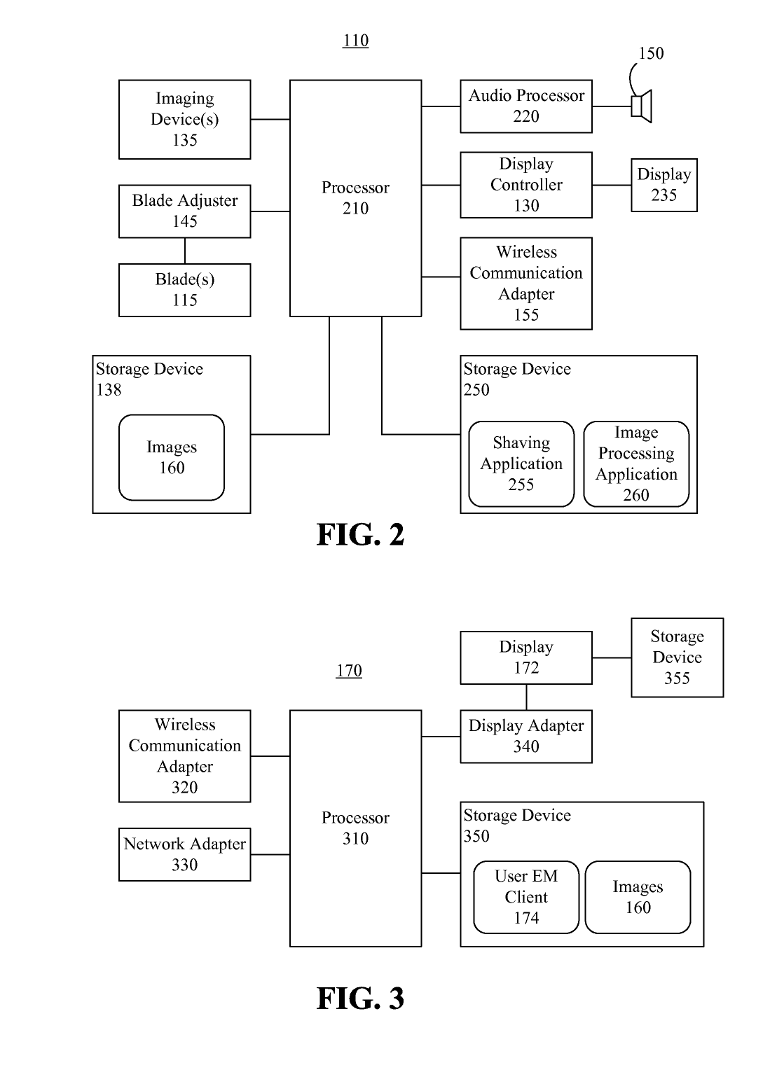

FIG. 2 depicts a block diagram of the razor 110, which is useful for understanding various arrangements described herein. The razor 110 includes at least one processor (or controller) 210, which is described (but not shown) with reference to FIG. 1. The razor 110 also can include an audio processor 220, which is described (but not shown) with reference to FIG. 1. As noted, the audio processor 220 can be a discrete processor communicatively linked to the processor 210, or integrated within the processor 210. The audio processor 220 can receive signals generated by the processor 210 and process the audio signals into a format suitable to be output by the output audio transducer 150. For example, the audio processor 220 can perform digital to audio (D/A) conversion on such signals.

The razor 110 further can include a display controller 230 that receives video signals from the processor 210, and processes such video signal into a format suitable to drive a display 235. As noted, the display 235 can be a LCD display or any other suitable display which may be incorporated into the razor 110. The display controller 130 can be a display controller integrated within the processor 210, a stand-alone controller, or a controller integrated within the display 235.

The razor 110 also can include a wireless communication adapter 155. The wireless communication adapter 155 also can be a discrete device communicatively linked to the processor 210, or integrated within the processor 210. The wireless communication adapter 155 can include a transmitter or transceiver suitable for communicating with the processing system 170 of FIG. 1. In this regard, the wireless communication adapter 155 can be configured to communicate information in accordance with any suitable wireless communication protocols, such as those previously described. If wired communications are used between the razor 110 and the processing system 170 (of FIG. 1), a suitable communication adapter can be used in lieu of, or in addition to, the wireless communication adapter 155, as would be known to those skilled in the art.

The razor 110 further comprises the imaging device(s) 135 and the blade adjuster 145, both of which are communicatively linked to the processor 210. As noted, the blade adjuster 145 can adjust the position of the blades 115 with respect to the user's skin, as previously described. The razor 110 further includes the output audio transducer 150, which is communicatively linked to the audio processor 220. The razor 110 also includes a storage device 250 having stored thereon machine-readable (or computer-readable) program code configured to, when executed by the processor 210, configures the processor 210 to perform the functions and operations described herein as being performed by the razor 110. In illustration, a shaving application 255 can be stored on the storage device 250 in the form of executable program.

An image processing application 260 also can be stored on the storage device in the form of executable program code. The image processing application 260, when executed by the processor 210, can process images captured by the imaging device(s) 135 to identify areas of the skin sensitive to shaving, skin diseases, and any other undesirable skin conditions. In illustration, the image processing application 260 can access a data table, data base, or other information source that includes parameters related to skin diseases and/or skin conditions. When processing the images, the image processing application 260 can determine whether the images correlate to any such parameters using known imaging processing techniques and, if so, identify in the images the skin diseases and/or skin conditions associated with such parameters. The image processing application 260 can communicate any identified skin diseases and/or skin conditions to the shaving application 255. In one arrangement, the image processing application 260 can be a component of the shaving application 255, though the present arrangements are not limited in this regard.

In one arrangement, the images 160 of the skin can be stored to the storage device 250. In another arrangement, the razor 110 further can include the storage device 138, and the images 160 of the skin can be stored to the storage device 138. As noted, the storage device 138 can be removably attached to the razor 110. Thus, the storage device 138 can be removed from the razor 110 and attached to another device or system to retrieve the images 160. In another arrangement, the images 160 can be stored, at least temporarily, to the storage device 138 at least until the images are communicated to another device or system via the wireless communication adapter 155.

FIG. 3 depicts a block diagram the processing system 170, which is useful for understanding various arrangements described herein. The processing system 170 includes a processor (or controller) 310. The processing system 170 also can include a wireless communication adapter 320 configured to wirelessly communicate with the razor, for example as previously described. If wired communications are used between the communication device and the processing system 170, a suitable communication adapter can be used in lieu of, or in addition to, the wireless communication adapter 320, as would be known to those skilled in the art.

The processing system 170 also can include a network adapter 330 that enables communications between the processing system 170 and the communication network(s) 180 of FIG. 1. Such network adapters are known to those skilled in the art. In one non-limiting arrangement, the wireless communication adapter 320 and the network adapter 330 can be the same device. Moreover, in lieu of the wireless communication adapter 320, the processor 310 can communicate with the razor via the network adapter 330 using wired communications, as previously described. Still, any number of communication adapters can be used to support various communications and the invention is not limited in this regard.

The processing system 170 further can include a display adapter 340 that receives the image(s) from the razor, processes the images, and outputs the images to the display 172. In one arrangement, the display adapter 340 can be integrated with the processor 310, though this need not be the case. For example, the display adapter 340 can be a stand-alone display adapter, or integrated within the display 172.

The processing system 170 also can include a storage device 350. The storage device 350 can store the user EM client 174, having stored thereon machine-readable (or computer-readable) program code configured to, when executed by the processor 310, configures the processor 310 to perform the functions and operations described herein as being performed EM client 174. In illustration, the EM client 174 can be stored on the storage device 350 in the form of executable program code executable by the processor 310. The storage device 350 also can store other applications or software, such as an operating system, etc.

In one arrangement, the storage device 350 can store, at least temporarily, the images 160 received from the razor 110. For example, the storage device 350 can store the images until the images 160 are communicated to another device or system, for instance as described herein, or until the images 160 are removed (e.g., moved or deleted) from the storage device 350 by the user. In a further arrangement, the images can be stored, at least temporarily, to a storage device 355 removably attached to the processing system 170. In one non-limiting embodiment, the storage device 355 can be removably attached directly to the display 172, though the present arrangements are not limited in this regard. Accordingly, a user can remove the storage device 355 and access the images 160 from another suitable device to which the storage device 355 later is connected. In illustration, the storage device 355 can be a memory card comprising flash memory, a flash drive, or the like.

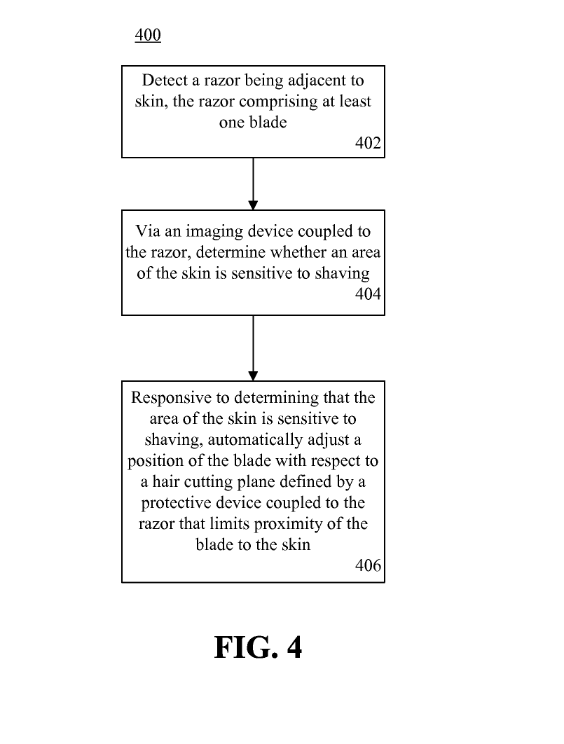

FIG. 4 is a flowchart presenting a method 400 of controlling a razor, which is useful for understanding various arrangements described herein. At step 402, a razor being adjacent to skin can be detected, the razor comprising at least one blade. At step 404, via an imaging device coupled to the razor, whether an area of the skin is sensitive to shaving can be identified. At step 406, responsive to determining that the area of the skin is sensitive to shaving, a position of the blade is automatically adjusted with respect to a hair cutting plane defined by a protective device coupled to the razor that limits proximity of the blade to the skin.

Additional processes also can be implemented. For example, an alert indicating that the area of the skin is sensitive to shaving can be automatically generated in response to determining that the area of the skin is sensitive to shaving. The alert can be presented to a user of the razor, for example as an audible alert presented via the output audio transducer of the razor or as a message communicated to the user via a display integrated into the razor or via an external display, such as any of those described herein. Further, a message indicating a type of blade that should be used for shaving can be automatically generated. The type of blade is selected for sensitive skin. The message can be presented to a user of the razor, for example via a display integrated into the razor, via an external display, or via an audio message presented via the output audio transducer of the razor (or another output audio transducer communicatively linked to the razor).

Other processes also can include, via the imaging device coupled to the razor, capturing an image of the area of the skin that is sensitive to shaving and communicating the image of the area of the skin that is sensitive to shaving to a medical practitioner. For example, the image can be attached to an electronic message, and the electronic message can be communicated to the medical practitioner.

In a further arrangement, via the imaging device coupled to the razor, at least one image of the skin can be captured while the blade is adjacent to the skin. The image can be communicated to a display integrated into a mirror, a tablet computer, a smart phone, or any other device that includes, or is attached to, a display. The display integrated into the mirror, the tablet computer or the smart phone can be automatically activated when the razor is turned on. Further, the razor can detect that a charge level of a battery of the razor is low, and communicate an alert to a display external to the razor (e.g., the display integrated into the mirror, the tablet computer or the smart phone) indicating the charge level of the battery is low. The display can present such message to the user.

The flowchart and block diagrams in the figures illustrate the architecture, functionality, and operation of possible implementations of systems, methods and computer program products according to various embodiments described herein. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

These executable instructions may be stored as program code on a computer-readable storage device. When executed by a processor, the program code can configure the processor to perform executable operations described herein. In this regard, the program code can direct the processor, other programmable data processing apparatus, or other devices to function in a particular manner, such that the instructions stored in the computer-readable storage device produce an article of manufacture (e.g., a computer program product) including instructions which implement the function/act specified in the flowchart and/or block diagram block or blocks.

The executable instructions may also be loaded onto a processor, other programmable data processing apparatus, or other devices to cause a series of operational steps to be performed on the processor, other programmable apparatus or other devices to produce a computer implemented process such that the instructions which execute on the processor or other programmable apparatus provide processes for implementing the functions/acts specified in the flowchart and/or block diagrams block or blocks.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

These embodiments can be embodied in other forms without departing from the spirit or essential attributes thereof. Accordingly, reference should be made to the following claims, rather than to the foregoing specification, as indicating the scope of the embodiments.

What is claimed is:

1. A method of controlling a razor comprising:
detecting the razor being adjacent to skin, the razor comprising at least one blade;
via an imaging device coupled to the razor, determining whether an area of the skin is sensitive to shaving; and
responsive to determining that the area of the skin is sensitive to shaving, automatically adjusting a position of the blade with respect to a hair cutting plane defined by a protective device coupled to the razor that limits proximity of the blade to the skin.

2. The method of claim 1, further comprising:
responsive to determining that the area of the skin is sensitive to shaving, automatically generating an alert indicating that the area of the skin is sensitive to shaving; and
presenting the alert to a user of the razor.

3. The method of claim 1, further comprising:
responsive to determining whether an area of the skin is sensitive to shaving, automatically generating a message indicating a type of blade that should be used for shaving, the type of blade selected for sensitive skin; and
presenting the message to a user of the razor.

4. The method of claim 1, further comprising:
responsive to determining that the area of the skin is sensitive to shaving:
via the imaging device coupled to the razor, capturing an image of the area of the skin that is sensitive to shaving; and
communicating the image of the area of the skin that is sensitive to shaving to a medical practitioner.

5. The method of claim 4, wherein communicating the image of the area of the skin that is sensitive to shaving to the medical practitioner comprises:
attaching the image to an electronic message; and
communicating the electronic message to the medical practitioner.

6. The method of claim 1, further comprising:
via the imaging device coupled to the razor, capturing at least one image of the skin while the blade is adjacent to the skin; and
communicating the at least one image of the skin to a display integrated into a mirror.

7. The method of claim 6, further comprising:
activating the display integrated into the mirror when the razor is turned on.

8. The method of claim 1, further comprising:
via the imaging device coupled to the razor, capturing at least one image of the skin while the blade is adjacent to the skin; and
communicating the at least one image of the skin to a tablet computer or a smart phone.

9. The method of claim 8, further comprising:
activating the tablet computer or smart phone when the razor is turned on.

10. The method of claim 1, the method further comprising:
detecting that a charge level of a battery of the razor is low; and
communicating an alert to a display external to the razor indicating the charge level of the battery is low.

11. A razor, comprising:
at least one blade; and
a processor configured to initiate executable operations comprising:
detecting that the razor is adjacent to skin;
via an imaging device coupled to the razor, determining whether an area of the skin is sensitive to shaving; and
responsive to determining that the area of the skin is sensitive to shaving, automatically adjusting a position of the blade with respect to a hair cutting plane defined by a protective device coupled to the razor that limits proximity of the blade to the skin.

12. The razor of claim 11, wherein the processor further is configured to initiate executable operations comprising:
responsive to determining that the area of the skin is sensitive to shaving, generating an alert indicating that the area of the skin is sensitive to shaving; and
presenting the alert to a user of the razor.

13. The razor of claim 11, wherein the processor further is configured to initiate executable operations comprising:
responsive to determining whether an area of the skin is sensitive to shaving, automatically generating a message indicating a type of blade that should be used for shaving, the type of blade selected for sensitive skin; and
presenting the message to a user of the razor.

14. The razor of claim 11, wherein the processor further is configured to initiate executable operations comprising:
responsive to determining that the area of the skin is sensitive to shaving:
via the imaging device coupled to the razor, capturing an image of the area of the skin that is sensitive to shaving; and
communicating the image of the area of the skin that is sensitive to shaving to a medical practitioner.

15. The razor of claim 14, wherein communicating the image of the area of the skin that is sensitive to shaving to the medical practitioner comprises:
attaching the image to an electronic message; and
communicating the electronic message to the medical practitioner.

16. The razor of claim 11, wherein the processor further is configured to initiate executable operations comprising:
via the imaging device coupled to the razor, capturing at least one image of the skin while the blade is adjacent to the skin; and
communicating the at least one image of the skin to a display integrated into a mirror.

17. The razor of claim 16, wherein the processor further is configured to initiate executable operations comprising:
activating the display integrated into the mirror when the razor is turned on.

18. The razor of claim 11, wherein the processor further is configured to initiate executable operations comprising:
via the imaging device coupled to the razor, capturing at least one image of the skin while the blade is adjacent to the skin; and
communicating the at least one image of the skin to a tablet computer or a smart phone.

19. The razor of claim 18, wherein the processor further is configured to initiate executable operations comprising:
activating the tablet computer or smart phone when the razor is turned on.

20. The razor of claim 11, wherein the processor further is configured to initiate executable operations comprising:
detecting that a charge level of a battery of the razor is low; and
communicating an alert to a display external to the razor indicating that the charge level of the battery is low.

21. A computer program product for controlling a razor, said computer program product comprising:
a computer-readable storage device having stored thereon program code that, when executed, configures a processor to perform executable operations comprising:
detecting the razor being adjacent to skin, the razor comprising at least one blade;
via an imaging device coupled to the razor, determining whether an area of the skin is sensitive to shaving; and
responsive to determining that the area of the skin is sensitive to shaving, automatically adjusting a position of the blade with respect to a hair cutting plane defined by a protective device coupled to the razor that limits proximity of the blade to the skin.

22. The computer program product of claim 21, wherein the program code, when executed, further configures the processor to perform executable operations comprising:
responsive to determining that the area of the skin is sensitive to shaving, automatically generating an alert indicating that the area of the skin is sensitive to shaving; and
presenting the alert to a user of the razor.

23. The computer program product of claim 21, wherein the program code, when executed, further configures the processor to perform executable operations comprising:
responsive to determining whether an area of the skin is sensitive to shaving, automatically generating a message indicating a type of blade that should be used for shaving, the type of blade selected for sensitive skin; and
presenting the message to a user of the razor.
